(19) United States
(12) Patent Application Publication
(10) Pub. No.: US 2026/0120923 A1
(43) Pub. Date: Apr. 30, 2026

(54) GROMMET

(71) Applicant: YAZAKI CORPORATION, Tokyo (JP)

(72) Inventors: Hirotaka Kiyota, Makinohara-shi (JP); Takeshi Onoda, Makinohara-shi (JP); Toshinori Yamada, Makinohara-shi (JP)

(21) Appl. No.: 19/084,708

(22) Filed: Mar. 19, 2025

Related U.S. Application Data
(63) Continuation of application No. PCT/JP2024/001307, filed on Jan. 18, 2024.

(30) Foreign Application Priority Data
Feb. 20, 2023 (JP) 2023-023931

(51) Int. Cl. H01B 17/58

(52) U.S. Cl. CPC H01B 17/583

(57) ABSTRACT

A water stop member includes an annular main body to be coaxially engaged with a flange surface at an assembly completion position with a base member, an annular outer circumferential lip that is coaxially protruded from an inner circumference portion of a main body toward a circumference portion, elastically deforms at an attachment completion position, and is brought into close contact with an annular plane of the circumference portion over one circumference, an annular inner circumferential lip that is coaxially arranged at a position closer to a cylindrical portion side than the outer circumferential lip, and is brought into close contact with the annular plane over one circumference at the attachment completion position, and a connection member.

### CROSS-REFERENCE TO RELATED APPLICATION(S)

This application is a continuation application of International Application PCT/JP2024/001307, filed on Jan. 18, 2024 which claims the benefit of priority from Japanese Patent Application No. 2023-023931 filed on Feb. 20, 2023 and designating the U.S., the entire contents of which are incorporated herein by reference.

### BACKGROUND OF THE INVENTION

### 1. Field of the Invention

The present invention relates to a grommet.

### 2. Description of the Related Art

Conventionally, in a wiring harness, by inserting a wiring material such as an electric wire into a through-hole provided in an insertion target object (for example, a panel of a vehicle body in a vehicle, or the like), the wiring material is drawn in from one space partitioned by this insertion target object, to a different space. Thus, in order to protect the wiring material from the circumference of the through-hole, and prevent the entry of liquid into a clearance gap between the through-hole and the wiring material, a grommet blocking the clearance gap is attached to the insertion target object. For example, the grommet is formed of a base member made of hard synthetic resin material, and an annular water stop member made of a flexible synthetic resin material such as rubber, and is inserted into the through-hole, whereby the water stop member is brought into close contact with the circumference of the through-hole in the insertion target object. For example, Japanese Patent Application Laid-open No. 8-251769 described below discloses a grommet formed in this manner.

On the other hand, in a conventional grommet, in order to improve waterproofness between the water stop member and the circumference of the through-hole, an annular lip is sometimes provided on the water stop member. This lip is protruded in an insertion direction into the through-hole in the grommet, and when the grommet is assembled to the circumference of the through-hole, it is brought into contact with the circumference and stick it while bending. Thus, in the grommet of this type, the lip causes an increase in insertion force toward the through-hole.

### SUMMARY OF THE INVENTION

In view of the foregoing, the object of the present invention is to provide a grommet that can reduce insertion force.

A grommet according to one aspect of the present invention includes a base member that is made of synthetic resin material, and inserts a conductive wiring material laid from one space to a different space through a through-hole of an insertion target object, thereinside; and an annular grommet main body arranged in the one space at an attachment completion position to a circumference portion of the through-hole of the insertion target object, by being assembled to the base member, wherein the base member includes an annular flange having an annular flange surface arranged in the one space at the attachment completion position, and coaxially arranged to face an annular plane on a side of the one space of the annular circumference portion with a clearance gap, and a cylindrical portion coaxially protruded from the flange toward the different space, and inserted into the through-hole at the attachment completion position, and a plurality of engagement portions protruded from an outer circumferential surface of the cylindrical portion in the different space at the attachment completion position, and brought into contact with the circumference portion from a side of the different space in the different space at the attachment completion position, in a circumferential direction of the cylindrical portion, the grommet main body includes an annular water stop member made of elastically deformable synthetic resin material softer than the base member, and the water stop member includes an annular main body to be coaxially engaged with the flange surface at an assembly completion position with the base member, an annular outer circumferential lip that is coaxially protruded from an inner circumference portion of the main body toward the circumference portion, elastically deforms at the attachment completion position, and is brought into close contact with the annular plane of the circumference portion over one circumference, an annular inner circumferential lip that is coaxially arranged at a position closer to the cylindrical portion side than the outer circumferential lip, and is brought into close contact with the annular plane of the circumference portion over one circumference at the attachment completion position, and a connection member that is arranged at an interval from the flange surface at the assembly completion position, connects a root of the inner circumferential lip to a root on a side of the main body of the inner circumference portion of the main body or/and the outer circumferential lip, receives force from the inner circumferential lip at the attachment completion position, and bend-deforms toward a side of the flange surface.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a grommet of an embodiment before being attached to an insertion target object;

FIG. 2 is a perspective view illustrating a grommet of an embodiment viewed from another angle;

FIG. 3 is a plan view illustrating a grommet of an embodiment viewed from a cylindrical portion side;

FIG. 4 is a diagram corresponding to an X-X line cross section in FIG. 3, and illustrates a state caused before attachment to an insertion target object;

FIG. 5 is a diagram corresponding to the X-X line cross section in FIG. 3, and illustrates a state caused after attachment to an insertion target object;

FIG. 6 is an exploded perspective view illustrating a grommet of an embodiment;

FIG. 7 is an exploded perspective view illustrating a grommet of an embodiment viewed from another angle;

FIG. 8 is an exploded perspective view separately illustrating two base members and a grommet main body that are attached to a grommet of an embodiment;

FIG. 9 is an exploded perspective view of a base member and a waterproof member according to an embodiment; and

FIG. 10 is an exploded perspective view of a grommet main body of an embodiment.

### DETAILED DESCRIPTION OF THE PREFERRED EMBODIMENTS

A grommet according to an embodiment of the present invention will be described in detail below based on the drawings. In addition, the present invention is not limited by the embodiment.

### Embodiment

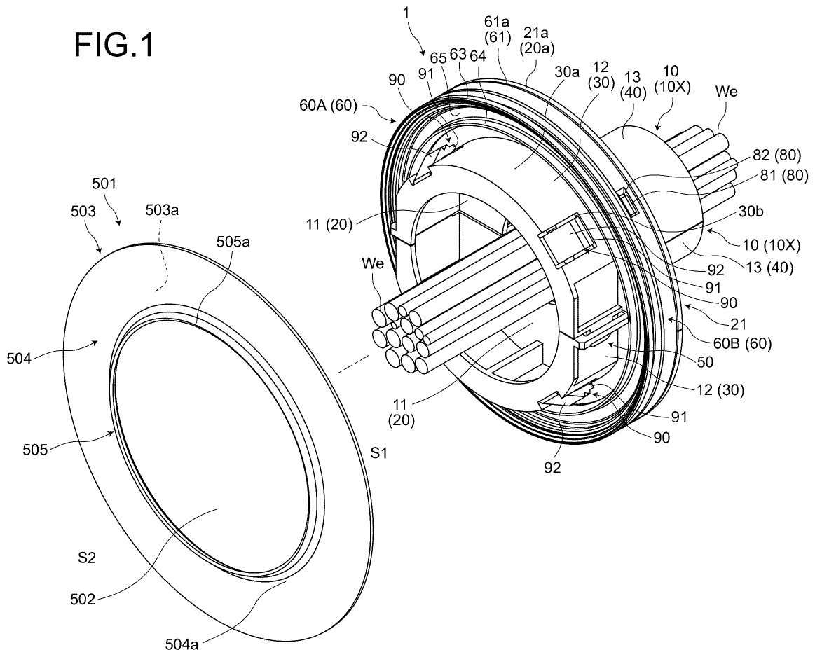

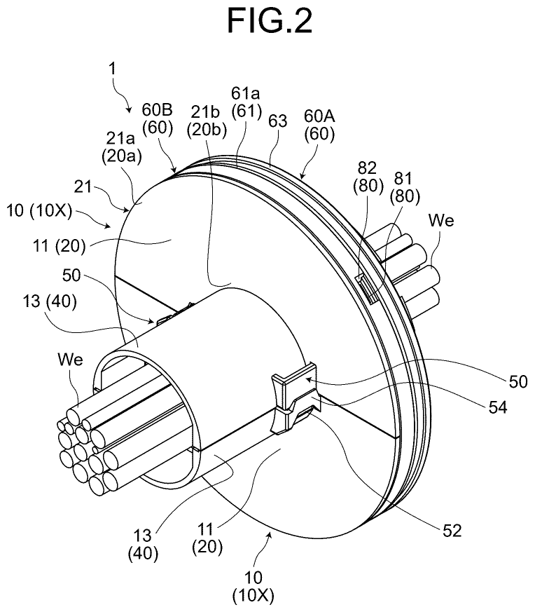

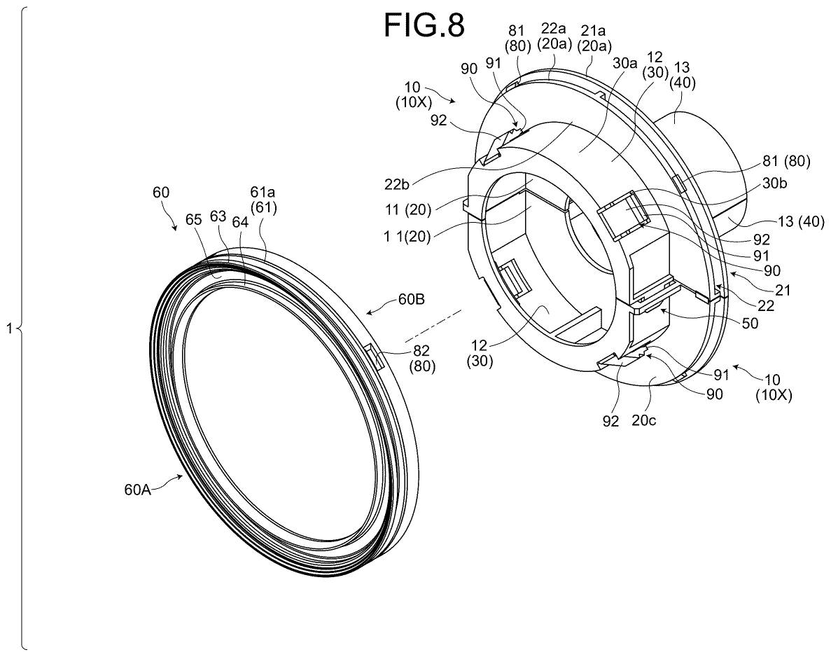

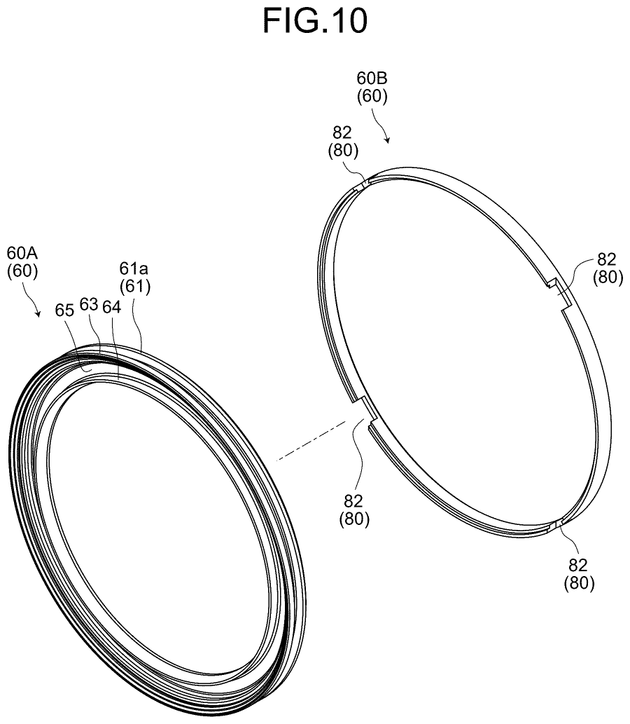

One of grommets according to the present invention will be described based on FIGS. 1 to 10.

A sign 1 in FIGS. 1 to 8 denotes a grommet of the present embodiment. The grommet 1 protects a conductive the wiring material We laid from one space S1 to a different space S2 through a through-hole 502 of an insertion target object 501, from a circumference portion 503 of the through-hole 502 in the insertion target object 501, and prevents the entry of liquid (water, etc.) into a clearance gap between the annular circumference portion 503 and the wiring material We (FIGS. 1, 4, and 5). Therefore, the grommet 1 is attached to the circumference portion 503 of the through-hole 502 of the insertion target object 501 after the insertion of the wiring material We.

Here, the wiring material We refers to, for example, an electric wire (an electric wire serving as a communication wire, an electric wire serving as a power wire, or the like). In addition, the insertion target object 501 is a member for inserting the wiring material We, and refers to a wall member such as a panel of a vehicle body in the case of a vehicle, for example. By being inserted into the through-hole 502 of the insertion target object 501, the wiring material We is laid between the one space S1 and the different space S2 partitioned by the insertion target object 501. For example, the wiring material We undertakes a role of communication between apparatuses of the one space S1 and the different space S2, and undertakes a role of power supply or the like from a power source of the different space S2 to an electric device in the one space S1.

The circumference portion 503 of the through-hole 502 of the insertion target object 501 includes an annular flat panel portion (hereinafter, will be referred to as a “annular flat panel portion”.) 504, and an annular protruding portion (hereinafter, will be referred to as a “annular protruding portion”.) 505 (FIGS. 1, 4, and 5) protruded toward the different space S2 from an end portion of an inner circumference (inner circumference portion 504a) of the annular flat panel portion 504. The grommet 1 is attached to the annular flat panel portion 504 and the annular protruding portion 505 at the circumference portion 503. For example, the insertion target object 501 is formed by pressure molding, and at the time, the annular flat panel portion 504 and the through-hole 502 are formed. Then, in the insertion target object 501, by burring processing on the circumference of the through-hole 502, the annular protruding portion 505 is formed. Here, because the through-hole 502 is formed into a round shape, the annular flat panel portion 504 and the annular protruding portion 505 are each formed into an annular shape.

The grommet 1 includes a base member 10X that causes the wiring material We to be inserted thereinto (FIGS. 1 to 9). The base member 10X may be one member, or may be a plurality of assembled members. The base member 10X illustrated here includes two base members (first base member, second base member) to be assembled to each other. The two base members may be members having different shapes, or may be members having the same shape. In the grommet 1 illustrated here, the same members (base members 10, 10) having the same shape are used as the two base members (FIGS. 1 to 9).

The base member 10X coaxially includes at least an annular flange 20 and a cylindrical portion 30, and causes the wiring material We to be inserted into these (FIGS. 1 and 3 to 9). In addition to the flange 20 and the cylindrical portion 30, the base member 10X illustrated here includes a tubular member 40 coaxially with these, and causes the wiring material We to be inserted into these (FIGS. 1, 2, and 4 to 9). Here, the cylindrical portion 30 is coaxially protruded toward one side from the flange 20, and the tubular member 40 is coaxially protruded toward a different side from the flange 20.

In the base member 10X illustrated here, as described later, by the base members 10 and 10 assembled to each other, the annular flange 20, the cylindrical portion 30, and the tubular member 40 are coaxially formed. Thus, a holding mechanism (hereinafter, will be referred to as a “base holding mechanism”.) 50 that holds the two base members 10 and 10 while keeping these in an assembled state is provided between the two base members 10 and 10 (FIGS. 1, 2, and 6 to 9).

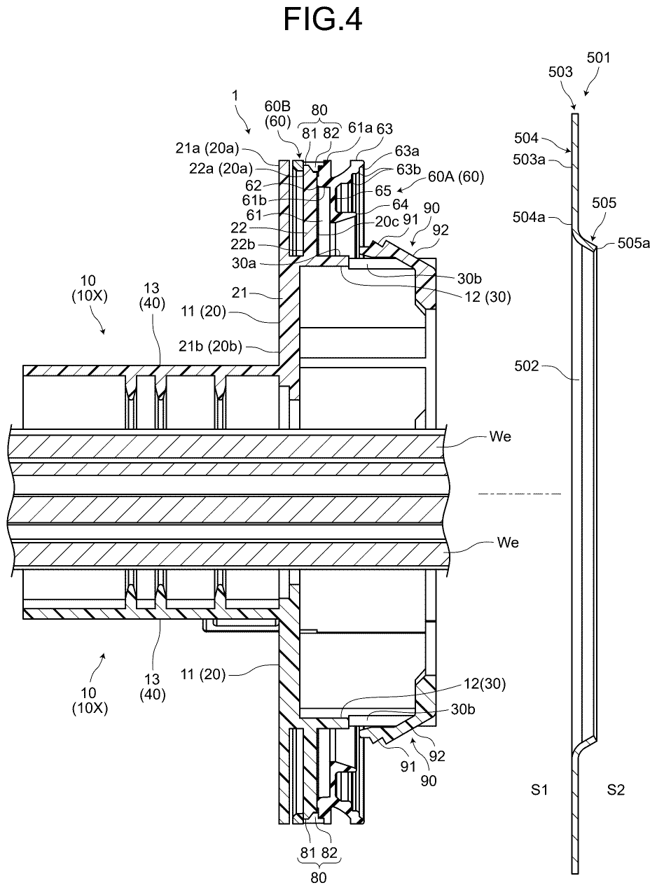

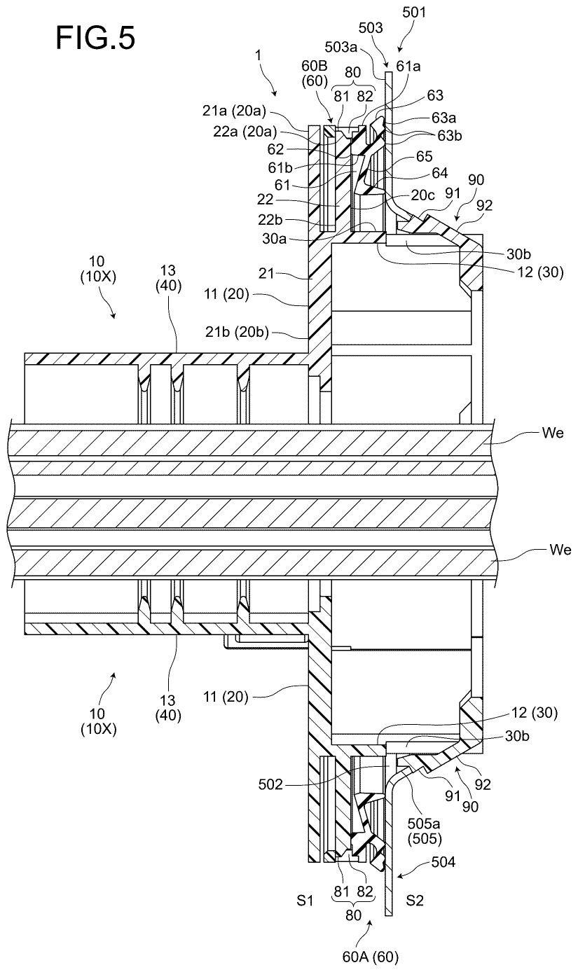

In addition, the grommet 1 includes an annular grommet main body 60 to be assembled to the base member 10X (the base members 10 and 10 assembled to each other) (FIGS. 1 to 8, and 10). In order to prevent entry of liquid (water, etc.) into the different space S2 from the one space S1 via the through-hole 502, the grommet main body 60 is arranged in the one space S1 at an attachment completion position of the grommet 1 with respect to the circumference portion 503 (FIGS. 4 and 5). In addition, hereinafter, in a case where an “attachment completion position” is simply described, the position refers to an attachment completion position of the grommet 1 with respect to the circumference portion 503.

The base members 10X (the base members 10 and 10) are molded using an insulating hard synthetic resin material (hereinafter, will be referred to as “hard resin”). Here, for example, the base member 10X (the base members 10 and 10) are molded using hard resin such as plastic.

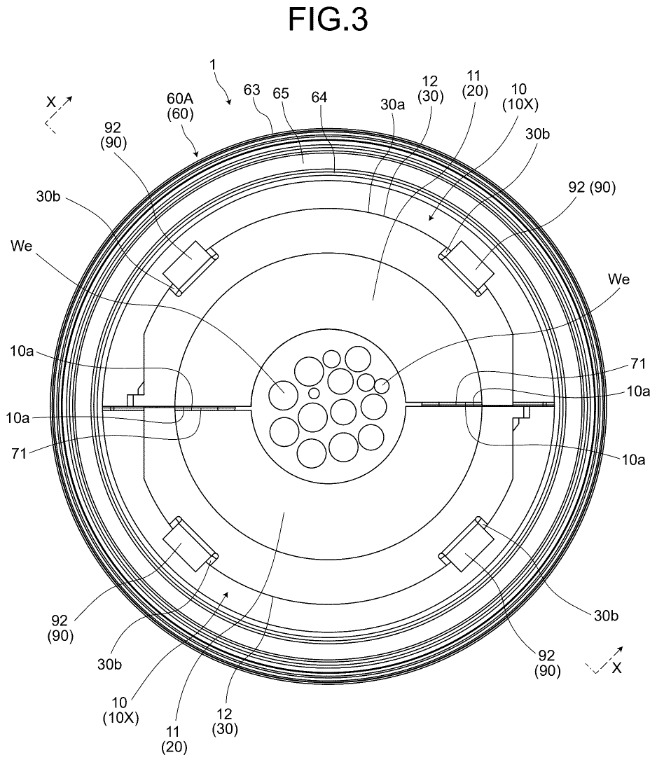

The two base members 10 and 10 assembled by coupling their respective bonded surfaces 10a (FIGS. 3, 6, 7, and 9). The two base members 10 and 10 sandwich the wiring material We with being in the assembled state, and brings the wiring material We into an inserted state. Here, by assembling the two base members 10 and 10, the flange 20 having an annular shape, the cylindrical portion 30 having a cylindrical shape, and the tubular member 40 having a circular tube shape are formed. In addition, here, the tubular member 40 having a straight tube is used as an example. Nevertheless, the tubular member 40 may be bent after being protruded from the flange 20.

The flange 20 is arranged in the one space S1 at the attachment completion position, and is coaxially arranged in such a manner as to face an annular plane 503a on the one space S1 side in the circumference portion 503 with a clearance gap (FIG. 5). The annular plane 503a is provided in the annular flat panel portion 504. The annular plane 503a illustrated here is an annular plane itself on the one space S1 side of the annular flat panel portion 504. This flange 20 coaxially arranges an annular outer circumference portion (hereinafter, will be referred to as a “flange outer circumference portion”.) 20a side in such a manner as to face the annular plane 503a with a clearance gap in a hole axis direction of the through-hole 502 at the attachment completion position (FIG. 5). Then, the flange 20 inserts the wiring material We into the inner side of an annular inner circumference portion (hereinafter, will be referred to as a “flange inner circumference portion”.) 20b (FIGS. 4 and 5).

The flange 20 is formed into a plate shape. Thus, on the flange outer circumference portion 20a side of the flange 20, an annular wall surface (hereinafter, will be referred to as a “flange surface”.) 20c that is coaxially arranged in such a manner as to face the annular plane 503a with a clearance gap at the attachment completion position is provided (FIGS. 4 to 8). Here, the flange 20 is formed into an annular shape.

The two base members 10 and 10 respectively include divided flanges 11 that form the flange 20 by coupling their respective bonded surfaces 10a (FIGS. 1 to 8). The divided flanges 11 illustrated here are obtained by dividing the flange 20 in half along a central axis, and are formed into a semicircular arcs shape.

The cylindrical portion 30 is coaxially protruded from the flange 20 toward the different space S2, and inserted into the through-hole 502 at the attachment completion position (FIGS. 4 and 5). That is, in the cylindrical portion 30, a leading end protruded from the flange 20 is arranged in the different space S2. The cylindrical portion 30 is formed into a cylindrical shape. The cylindrical portion 30 is protruded from a space between the flange outer circumference portion 20a and the flange inner circumference portion 20b in the flange 20, and inserts the wiring material We thereinto (FIGS. 4 and 5). Here, for example, the flange 20 is halved in its radial direction into the flange outer circumference portion 20a side and the flange inner circumference portion 20b side, and the cylindrical portion 30 is protruded from a boundary portion of the flange outer circumference portion 20a side and the flange inner circumference portion 20b side.

The two base members 10 and 10 respectively include divided cylinders 12 that form the cylindrical portion 30 by coupling their respective bonded surfaces 10a (FIGS. 1 and 3 to 8). The divided cylinders 12 illustrated here are obtained by dividing the cylindrical portion 30 in half along a central axis, and are formed into a semicircular arcs shape.

The tubular member 40 is coaxially protruded from the flange 20 in a direction opposite to the cylindrical portion 30 (FIGS. 4 and 5). The tubular member 40 is formed into a circular tube shape. The tubular member 40 illustrated here is protruded from the flange inner circumference portion 20b of the flange 20, and inserts the wiring material We thereinto (FIGS. 4 and 5).

The two base members 10 and 10 respectively include divided tubes 13 that form the tubular member 40 by coupling their respective bonded surfaces 10a (FIGS. 1, 2, and 4 to 8). The divided tube 13 illustrated here are obtained by dividing the tubular member 40 in half along a central axis, and are formed into a semicircular arcs shape.

Here, the flange 20 of this exemplification includes an annular plate-shaped first flange portion 21 connecting the flange outer circumference portion 20a and the flange inner circumference portion 20b, and an annular plate-shaped second flange portion 22 coaxially arranged in such a manner as to face the outer circumference portion 21a side and the annular plane 503a with a clearance gap between the outer circumference portion 21a side of the first flange portion 21 at the attachment completion position and the annular plane 503a of the circumference portion 503 (FIGS. 1, 2, 4, and 8). The second flange portion 22 has an outer diameter smaller than that of the first flange portion 21 by arranging the outer circumference portion 22a at a position closer to a hole axis side of the through-hole 502 than the outer circumference portion 21a of the first flange portion 21 in the radial direction (FIGS. 4 to 8). Nevertheless, the outer circumference portion 22a of the second flange portion 22 may be arranged at a position equivalent to the outer circumference portion 21a of the first flange portion 21 in the radial direction. In addition, the second flange portion 22 connects its inner circumference portion 22b to an outer circumferential surface 30a of the cylindrical portion 30 (FIGS. 4 to 6, and 8). Therefore, in the flange 20 of this exemplification, the flange outer circumference portion 20a side has a double-walled structure formed by the outer circumference portion 21a side of the first flange portion 21 and the second flange portion 22, and the flange inner circumference portion 20b side has a single-walled structure formed by the inner circumference portion 21b side of the first flange portion 21 (FIGS. 4 to 8). In this flange 20, the cylindrical portion 30 is protruded from the boundary portion of the outer circumference portion 21a side and the inner circumference portion 21b side of the first flange portion 21, and the cylindrical portion 30 is further protruded from the inner circumference portion 22b of the second flange portion 22. In addition, in this flange 20, a wall surface on the annular plane 503a side of the circumference portion 503 in the second flange portion 22 functions as the flange surface 20c coaxially arranged in such a manner as to face the annular plane 503a with a clearance gap.

As described above, the two base members 10 and 10 have major portions (the divided flange 11, the divided cylinder 12, the divided tube 13) with high hardness that are less elastically deformable. Thus, the two base members 10 and 10 might form a fine clearance gap attributed to surface roughness or the like of their bonded surfaces 10a, for example, between their bonded surfaces 10a. In view of the foregoing, the grommet 1 of the present embodiment includes a waterproof member 71 that is made of a synthetic resin material (hereinafter, will be referred to as “soft resin”) being elastically deformable and softer than the hard resin of the base member 10, and eliminates a clearance gap between their bonded surfaces 10a, on at least one of their bonded surfaces 10a of the two base members 10 and 10 (FIGS. 3, 6, 7, and 9) .

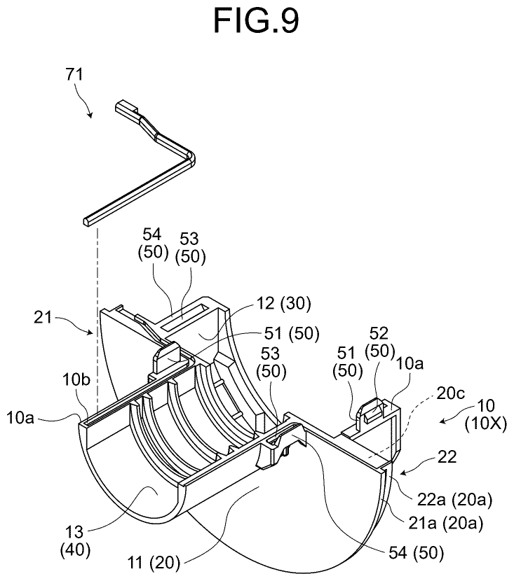

The waterproof member 71 is molded using synthetic resin material such as elastomer, for example. Then, the waterproof member 71 is provided over the bonded surfaces 10a of the divided flanges 11, the divided cylinders 12, and the divided tubes 13, for example. In the base members 10 illustrated here, a groove portion 10b is formed on one of the bonded surfaces 10a at two points from the divided flanges 11 to the divided tubes 13, and the waterproof member 71 is fitted into the groove portion 10b (FIG. 9). The waterproof member 71 is protruded from the groove portion 10b. For example, the waterproof member 71 is molded integrally with the base member 10 by being created by two-color molding with the base member 10, or being subjected to insert molding with respect to the base member 10 fitted in a mold. In addition, the waterproof member 71 is molded as a component different from the base member 10, and may be bonded to the groove portion 10b of the base member 10 using an adhesive or the like. In the base member 10X, by assembling the two base members 10 and 10, the waterproof member 71 protruded from the groove portion 10b of one bonded surface 10a of one base member 10 is brought into close contact with a different bonded surface 10a of a different base member 10.

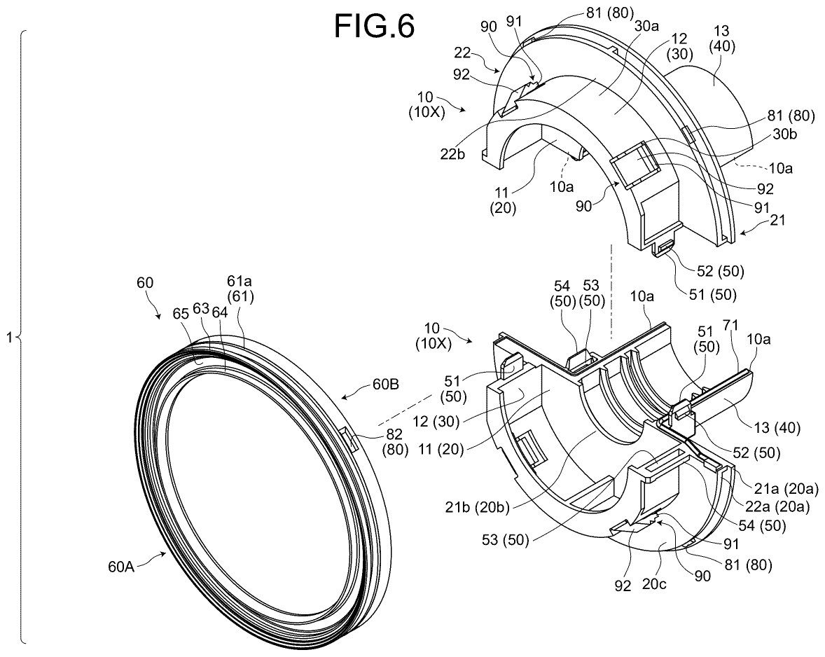

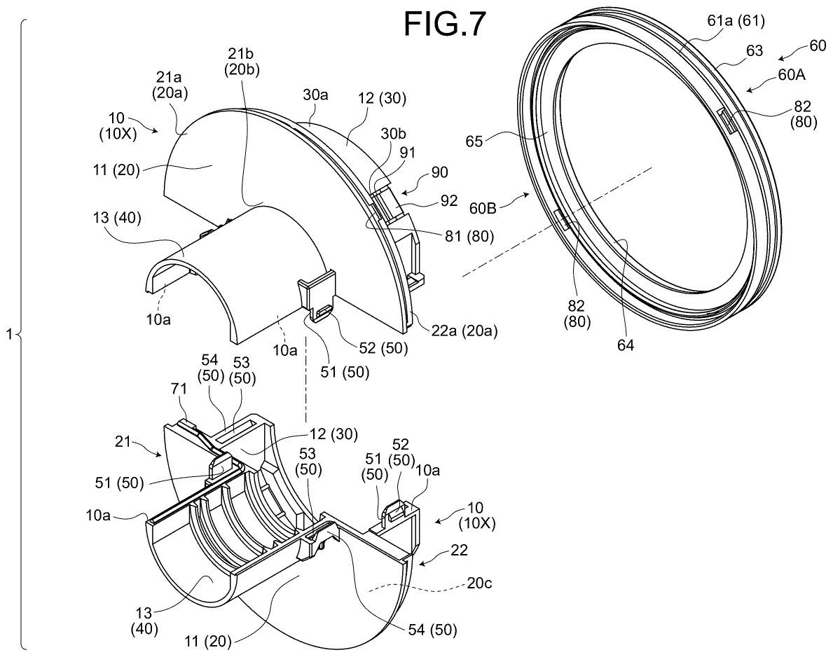

The base holding mechanism 50 is a holding mechanism for holding the respective bonded surfaces 10a of the two base members 10 and 10 in a coupled state. The base holding mechanisms 50 are provided at a plurality of points between the two base members 10 and 10. For example, the base holding mechanism 50 illustrated here includes a piece portion 51 protruded from one bonded surface 10a of the two base members 10 and 10, and a tab-shaped first engagement portion 52 protruded from the wall surface of the piece portion 51 (FIGS. 6 and 7). Then, the base holding mechanism 50 illustrated here includes an insertion port 53 provided on different bonded surface 10a of the two base members 10 and 10, into which one piece portion 51 thereof and the first engagement portion 52 are inserted, and a second engagement portion 54 that is provided on the different base member 10 of the two base members 10 and 10, is arranged to face the first engagement portion 52 when the respective bonded surfaces 10a are coupled, and holds the respective bonded surfaces 10a of the two base members 10 and 10 in a coupled state (FIGS. 6 and 7). The second engagement portion 54 has flexibility in such a manner as to bend by being pressed by the first engagement portion 52 inserted in the insertion port 53, and released from a bent state by the first engagement portion 52 being separated when the respective bonded surfaces 10a are coupled.

The two base members 10 and 10 illustrated here each include one set of the piece portion 51 and the first engagement portion 52 at one end in a circumferential direction of the divided cylinder 12, and one set of the insertion port 53, and the second engagement portion 54 at a different end in the circumferential direction of the divided cylinder 12. In the two base members 10 and 10, in a state in which their bonded surfaces 10a are coupled, the first engagement portion 52 at one end of one divided cylinder 12 and the second engagement portion 54 at a different end of a different divided cylinder 12 are engaged, and the second engagement portion 54 at a different end of the one divided cylinder 12 and the first engagement portion 52 at one end of the different divided cylinder 12 are engaged. That is, in the two base members 10 and 10, the base holding mechanisms 50 that link the respective divided cylinders 12 and hold these in a linked state are provided at two points. Furthermore, the two base members 10 and 10 each include one set of the piece portion 51 and the first engagement portion 52 at one end in a circumferential direction of the divided tube 13, and one set of the insertion port 53, and the second engagement portion 54 at a different end in the circumferential direction of the divided tube 13. In the two base members 10 and 10, in a state in which their bonded surfaces 10a are coupled, the first engagement portion 52 at one end of one divided tube 13 and the second engagement portion 54 at a different end of a different divided tube 13 are engaged, and the second engagement portion 54 at a different end of the divided tube 13 and the first engagement portion 52 at one end of the different divided tube 13 are engaged. That is, in the two base members 10 and 10, the base holding mechanisms 50 that link the respective divided tubes 13 and hold these in a linked state are provided at two points.

The grommet main body 60 includes an annular water stop member 60A made of soft resin (that is, elastically deformable synthetic resin material softer than the hard resin of the base member 10X (the base member 10) ), and an annular support member 60B that is made of synthetic resin material harder than the soft resin of the water stop member 60A, and integrated with the water stop member 60A (FIGS. 1, 2, 4 to 8, and 10). The water stop member 60A is molded using synthetic resin material such as an elastically deformable elastomer that is softer than the hard resin of the base member 10X (the base member 10) or the support member 60B, for example. In addition, the support member 60B is made of the same hard resin as the base member 10X (the base member 10) or hard resin that has hardness equivalent to the hard resin of the base member 10X (the base member 10) and is different from the hard resin, for example, and molded using synthetic resin material such as plastic.

The grommet main body 60 is formed as a molded component in which the water stop member 60A and the support member 60B are integrally molded. In the grommet main body 60, the water stop member 60A is integrated with the support member 60B. For example, the water stop member 60A is molded in a mold integrally with the support member 60B by being created by two-color molding with the support member 60B, or being subjected to insert molding with respect to the support member 60B fitted in a mold. In addition, the water stop member 60A is molded as a component different from the support member 60B, and may be bonded to the support member 60B using an adhesive or the like.

The grommet main body 60 assembles the base members 10X (the base members 10 and 10 assembled to each other) via the support member 60B.

The water stop member 60A includes an annular main body 61 that is coaxially engaged with the flange surface 20c of the flange 20 at an assembly completion position of the base members 10X (the base members 10 and 10 assembled to each other) (FIGS. 1, 2, 4 to 8, and 10). The main body 61 is formed into an annular plate shape. The main body 61 illustrated here protrudes its outer circumference portion 61a from the second flange portion 22 in the radial direction, and arranges the outer circumference portion 61a in such a manner as to face the outer circumference portion 21a of the first flange portion 21 with a clearance gap (FIGS. 4 and 5). In addition, hereinafter, in a case where an “assembly completion position” is simply described, the position refers to an assembly completion position of the base members 10X (the base members 10 and 10 assembled to each other) and the grommet main body 60.

The water stop member 60A illustrated here includes an annular lip (hereinafter, will be referred to as a “flange side lip”.) 62 that elastically deforms at its assembly completion position and is coaxially brought into close contact with the flange surface 20c over one circumference, and engages the main body 61 with the flange surface 20c via the flange side lip 62 (FIGS. 4 and 5). Therefore, the water stop member 60A coaxially arranges the main body 61 in such a manner as to face the flange surface 20c with a clearance gap at its assembly completion position, and coaxially protrudes the flange side lip 62 from the main body 61 toward the flange surface 20c.

Furthermore, the water stop member 60A includes an annular outer circumferential lip 63 that is coaxially protruded from an inner circumference portion 61b of the main body 61 toward the circumference portion 503, elastically deforms at the attachment completion position and is brought into close contact with the annular plane 503a of the circumference portion 503 over one circumference (FIGS. 1 to 8 and 10). The outer circumferential lip 63 is protruded toward the circumference portion 503 in such a manner as to be separated from the hole axis of the through-hole 502 as coaxially getting closer to the circumference portion 503 from the main body 61, bend-deforms at the attachment completion position, and is brought into close contact with the annular plane 503a of the circumference portion 503 over one circumference (FIGS. 4 and 5). The outer circumferential lip 63 includes two annular sub lip portions 63b provided on a wall surface 63a on the inner side in a radial direction and coaxially protruded from the wall surface 63a (FIGS. 4 and 5). The outer circumferential lip 63 brings the two sub lip portion 63b into close contact with the annular plane 503a of the circumference portion 503 by bend-deforming from the root on the main body 61 side at the attachment completion position.

In addition, furthermore, the water stop member 60A includes an annular inner circumferential lip 64 that is coaxially arranged at a position closer to the cylindrical portion 30 side than the outer circumferential lip 63, and brought into close contact with the annular plane 503a of the circumference portion 503 over one circumference at the attachment completion position (FIGS. 1, 3 to 8, and 10). Then, the water stop member 60A includes a connection member 65 arranged with a clearance gap from the flange surface 20c at the assembly completion position (FIGS. 1, 3 to 8, and 10). The connection member 65 connects the root of the inner circumferential lip 64 to the root on the main body 61 side of the inner circumference portion 61b of the main body 61 or/and the outer circumferential lip 63, receives force from the inner circumferential lip 64 at the attachment completion position, and bend-deforms toward the flange surface 20c side. The inner circumferential lip 64 receives elastic force caused by the elastic deformation of the connection member 65 to be brought into close contact with the annular plane 503a of the circumference portion 503.

One or a plurality of connection members 65 is provided in the water stop member 60A to connect the root on the main body 61 side of the inner circumference portion 61b of the main body 61 or/and the outer circumferential lip 63, and the inner circumferential lip 64. The connection member 65 illustrated here connects the inner circumferential lip 64 to the root on the main body 61 side of the outer circumferential lip 63. In addition, the number of the connection member 65 illustrated here that is provided in the water stop member 60A is one, and the connection member 65 is formed into an annular shape coaxially arranged at an interval from the flange surface 20c at the assembly completion position. The inner circumferential lip 64 is coaxially protruded toward the circumference portion 503 from the inner circumference portion of the connection member 65. Here, the connection member 65 is formed into an annular plate shape.

In the water stop member 60A, a plane of the main body 61, the flange side lip 62, and a plane of the connection member 65 that are positioned on the flange surface 20c side are formed by a mold (not illustrated) with a removal direction corresponding to one axial direction of the water stop member 60A. Thus, in the water stop member 60A, it is possible to improve mold releasability in removing the mold in the removal direction after molding.

Here, as described above, the outer circumferential lip 63 is protruded toward the circumference portion 503 in such a manner as to be separated from the hole axis of the through-hole 502 as coaxially getting closer to the circumference portion 503 from the main body 61, and coaxially protrudes two annular sub lip portions 63b from the wall surface 63a on the inner side in a radial direction. As described above, the inner circumferential lip 64 is coaxially protruded toward the circumference portion 503 from the inner circumference portion of the connection member 65. In the water stop member 60A, the inner side in the radial direction of the outer circumferential lip 63, the inner circumferential lip 64, and the plane on the circumference portion 503 side of the connection member 65 are formed by a mold (not illustrated) with a removal direction corresponding to a different axial direction of the water stop member 60A. Thus, in the water stop member 60A, by defining the shapes of the outer circumferential lip 63 and the inner circumferential lip 64 as shapes to be described below, it is possible to reduce load to be added to the outer circumferential lip 63 and the inner circumferential lip 64 from the mold when the mold is removed in the removal direction after molding.

In the outer circumferential lip 63, the wall surface 63a on the inner side in the radial direction is inclined in such a manner as to be separated from the axis of the water stop member 60A (the hole axis of the through-hole 502) as getting closer to the circumference portion 503. Then, the sub lip portion 63b is formed in such a manner that a cross-sectional shape orthogonal to the circumferential direction becomes a triangular shape, with the wall surface on the inner side in the radial direction being parallel to the axis of the water stop member 60A (the hole axis of the through-hole 502), and the wall surface of the circumference portion 503 side being a plane orthogonal to the axis of the water stop member 60A (the hole axis of the through-hole 502). With this configuration, in the water stop member 60A, it is possible to reduce load to be added to the outer circumferential lip 63 from the mold when removing the above-described mold in the removal direction after molding. Accordingly, in the water stop member 60A, it is possible to suppress quality degradation of the outer circumferential lip 63 in molding, and ensure waterproofness given by the outer circumferential lip 63.

The inner circumferential lip 64 vertically installs the wall surface on the outer side (outer circumferential lip 63 side) in the radial direction from the connection member 65. With this configuration, in the water stop member 60A, it is possible to reduce load to be added to the outer side in the radial direction of the inner circumferential lip 64 from the mold when removing the above-described mold in the removal direction after molding. In addition, the inner circumferential lip 64 inclines the wall surface on the inner side in the radial direction in such a manner as to be separated from the axis of the water stop member 60A (the hole axis of the through-hole 502) as getting closer to the circumference portion 503. With this configuration, in the water stop member 60A, it is possible to reduce load to be added to the inner side in the radial direction of the inner circumferential lip 64 from the mold when removing the above-described mold in the removal direction after molding. By employing such a shape of the inner circumferential lip 64, it is possible to reduce load to be added from the mold when removing the above-described mold in the removal direction after molding. Accordingly, in the water stop member 60A, it is possible to suppress quality degradation of the inner circumferential lip 64 in molding, and ensure waterproofness given by the inner circumferential lip 64.

The support member 60B is molded as an annular member that is integrated with the outer circumference portion 61a of the main body 61 of the water stop member 60A, and coaxially protruded from the outer circumference portion 61a toward the flange outer circumference portion 20a of the flange 20 (FIGS. 4 to 8 and 10). The support member 60B is molded into an annular shape. The support member 60B gets over the second flange portion 22 to be protruded up to a position where the support member 60B covers an annular clearance gap between the first flange portion 21 and the second flange portion 22 from the outer side in the radial direction.

An engagement mechanism 80 that engages a first engagement portion 81 provided on the base member 10X (the base members 10 and 10 assembled to each other), and a second engagement portion 82 provided on the support member 60B, and holds the base member 10X (the base members 10 and 10 assembled to each other) and the grommet main body 60 at the assembly completion position is provided between the base member 10X (the base members 10 and 10 assembled to each other) and the support member 60B (FIGS. 1, 2, and 4 to 8). The first engagement portion 81 is formed as a tab-shaped protruding portion protruded from the outer circumference portion 22a of the second flange portion 22 toward the outer side in the radial direction. In addition, the second engagement portion 82 is a through-hole formed on the support member 60B, and inserts the first engagement portion 81 at the assembly completion position and engages the first engagement portion 81 with its inner circumferential wall surface. A plurality of the engagement mechanisms 80 is provided around the axis of a cylinder axis of the base member 10X (the base members 10 and 10 assembled to each other). Here, four engagement mechanisms 80 are provided at equal intervals around the axis of a cylinder axis of the base members 10X, two of them are provided on the divided flanges 11 of one base member 10, and the remaining two are provided the divided flanges 11 of the other base member 10.

The grommet 1 having such a configuration includes a holding mechanism 90 that holds the mutually-assembled base members 10X (the mutually-assembled base members 10 and 10) and the grommet main body 60 at the circumference portion 503 of the through-hole 502 in the insertion target object 501 (FIGS. 1 and 3 to 8). The holding mechanism 90 illustrated here uses elastic force caused by elastic deformation of the outer circumferential lip 63 of the water stop member 60A, the inner circumferential lip 64, and the connection member 65, and holds the grommet 1 at the circumference portion 503 by sandwiching the circumference portion 503 using the outer circumferential lip 63 and the inner circumferential lip 64, and an engagement portion 91 that is described below and provided on the base member 10X (the base member 10).

The base member 10X includes the engagement portion 91 that is protruded from an outer circumferential surface 30a of the cylindrical portion 30 in the different space S2 at the attachment completion position, and brought into contact with the circumference portion 503 from the different space S2 side in the different space S2 at the attachment completion position (FIG. 1, and 4 to 8). The engagement portion 91 locks a part in the circumferential direction of the circumference portion 503. Therefore, the base member 10X includes a plurality of the engagement portions 91 in the circumferential direction of the cylindrical portion 30.

In addition, the base member 10X includes a cantilevered engagement piece portion 92 having the engagement portion 91 provided at a free end in the different space S2 at the attachment completion position, for each engagement portion 91 (FIGS. 1 and 3 to 8). The engagement piece portion 92 makes a portion protruded toward the one space S1 side from a fixed end on the outer circumferential surface 30a side of the cylindrical portion 30 in the different space S2 at the attachment completion position, a free end, and protrudes the free end side from the outer circumferential surface 30a of the cylindrical portion 30 (default shape). Then, the engagement piece portion 92 is formed to have flexibility that enables bend deformation of changing a protruding amount of the free end side from the outer circumferential surface 30a. By the bend deformation, the engagement piece portion 92 moves in a cutout portion 30b obtained by cutting out a part of the cylindrical portion 30 (FIGS. 1 and 3 to 8). A plurality of sets of a combination of the engagement portion 91, the engagement piece portion 92, and the cutout portion 30b is provided in the cylindrical portion 30 at equal intervals in the circumferential direction. In the cylindrical portion 30 illustrated here, four sets of a combination of the engagement portion 91, the engagement piece portion 92, and the cutout portion 30b is provided at equal intervals in the circumferential direction. Here, two sets of a combination of the engagement portion 91, the engagement piece portion 92, and the cutout portion 30b are provided on the divided cylinder 12 of each base member 10.

When the cylindrical portion 30 is inserted into the through-hole 502 from the one space S1, the engagement piece portion 92 receives force from the annular protruding portion 505 of the circumference portion 503 and bend-deforms toward the cutout portion 30b side from the default shape, passes through the position of the annular protruding portion 505, progresses up to the tip of the leading end (hereinafter, will be referred to as an “engagement end portion”) 505a of the annular protruding portion 505 (FIGS. 1, 4, and 5), and starts to return to the default shape if force received from the annular protruding portion 505 disappears. Thus, the engagement piece portion 92 is arranged at the tip of the engagement end portion 505a of the annular protruding portion 505 together with the engagement portion 91. On the other hand, in the water stop member 60A, when a series of movements of the engagement portion 91 and the engagement piece portion 92 are made, the outer circumferential lip 63 elastically deforms by contacting the annular plane 503a of the circumference portion 503, and the inner circumferential lip 64 elastically deforms the connection member 65 by contacting the annular plane 503a of the circumference portion 503. Therefore, if force for insertion into the through-hole 502 (so-called insertion force) is reduced, the grommet 1 makes a movement of returning toward the one space S1 side, by elastic force caused by elastic deformation of the outer circumferential lip 63 and the connection member 65. The engagement portion 91 accordingly contacts the engagement end portion 505a of the annular protruding portion 505, and is locked by the engagement end portion 505a (FIG. 5). That is, the annular protruding portion 505 locks the engagement portion 91 at the leading end (engagement end portion 505a) protruded from the annular flat panel portion 504. At the annular engagement end portion 505a, the engagement portion 91 is locked for each location in the circumferential direction. Accordingly, the circumference portion 503 is nipped by the outer circumferential lip 63 and the inner circumferential lip 64 of the water stop member 60A and £ each engagement portion 91 of the base member 10X (the base members 10 and 10).

In this manner, when the grommet 1 of the present embodiment is attached to the circumference portion 503 of the through-hole 502 of the insertion target object 501, the outer circumferential lip 63 elastically deforms by contacting the annular plane 503a of the circumference portion 503, and the inner circumferential lip 64 elastically deforms the connection member 65 by contacting the annular plane 503a of the circumference portion 503. Then, because the connection member 65 bends toward the flange surface 20c side, it is possible to suppress elastic deformation of the inner circumferential lip 64 that is caused by being pushed by the annular plane 503a of the circumference portion 503. Thus, in the grommet 1 according to the present invention, it becomes possible to reduce insertion force for insertion into the through-hole 502.

Meanwhile, the connection member 65 is arranged at an interval from the flange surface 20c at the assembly completion position as described above in order to bend deform when the grommet 1 is attached to the circumference portion 503 of the through-hole 502 of the insertion target object 501, but the connection member 65 may be brought into contact with the flange surface 20c during the attachment to the circumference portion 503, or may avoid being brought into contact with the flange surface 20c in a process of attachment to the circumference portion 503. Nevertheless, in the grommet 1, in a case where the connection member 65 is brought into contact with the flange surface 20c during the attachment to the circumference portion 503, bend deformation of the connection member 65 stops, and then, the inner circumferential lip 64 might elastically deform by being pushed by the annular plane 503a of the circumference portion 503. In this case, in the grommet 1, insertion force for insertion into the through-hole 502 is reduced until the connection member 65 contacts the flange surface 20c, and after the connection member 65 contacts the flange surface 20c, the insertion force becomes larger. In view of the foregoing, in the grommet 1, for example, it is desirable to prevent the connection member 65 from contacting the flange surface 20c during a process of attachment to the circumference portion 503 by arranging the connection member 65 at an interval from the flange surface 20c even at the attachment completion position. With this configuration, the grommet 1 can continue to reduce insertion force for insertion into the through-hole 502 until the attachment to the circumference portion 503 ends.

In addition, in the grommet 1 illustrated here, the annular outer circumferential lip 63 is protruded toward the circumference portion 503 in such a manner as to be separated from the hole axis of the through-hole 502 as coaxially getting closer to the circumference portion 503 from the main body 61. Thus, the outer circumferential lip 63 does not elastically deform by being pushed by the annular plane 503a of the circumference portion 503, and causes bend deformation by being pressed by the annular plane 503a. Thus, in the grommet 1, it becomes possible to further reduce insertion force for insertion into the through-hole 502.

When the grommet according to the present embodiment is attached to a circumference portion of a through-hole of an insertion target object, an outer circumferential lip elastically deforms by contacting an annular plane of the circumference portion, and an inner circumferential lip elastically deforms a connection member by contacting the annular plane of the circumference portion. Then, because the connection member bends toward a flange surface side, it is possible to suppress elastic deformation of the inner circumferential lip that is caused by being pushed by the annular plane of the circumference portion. Thus, in the grommet according to the present embodiment, it becomes possible to reduce insertion force for insertion into a through-hole.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A grommet comprising:
a base member that is made of synthetic resin material, and inserts a conductive wiring material laid from one space to a different space through a through-hole of an insertion target object, thereinside; and
an annular grommet main body arranged in the one space at an attachment completion position to a circumference portion of the through-hole of the insertion target object, by being assembled to the base member, wherein
the base member includes an annular flange having an annular flange surface arranged in the one space at the attachment completion position, and coaxially arranged to face an annular plane on a side of the one space of the annular circumference portion with a clearance gap, and a cylindrical portion coaxially protruded from the flange toward the different space, and inserted into the through-hole at the attachment completion position, and a plurality of engagement portions protruded from an outer circumferential surface of the cylindrical portion in the different space at the attachment completion position, and brought into contact with the circumference portion from a side of the different space in the different space at the attachment completion position, in a circumferential direction of the cylindrical portion,
the grommet main body includes an annular water stop member made of elastically deformable synthetic resin material softer than the base member, and
the water stop member includes an annular main body to be coaxially engaged with the flange surface at an assembly completion position with the base member, an annular outer circumferential lip that is coaxially protruded from an inner circumference portion of the main body toward the circumference portion, elastically deforms at the attachment completion position, and is brought into close contact with the annular plane of the circumference portion over one circumference, an annular inner circumferential lip that is coaxially arranged at a position closer to the cylindrical portion side than the outer circumferential lip, and is brought into close contact with the annular plane of the circumference portion over one circumference at the attachment completion position, and a connection member that is arranged at an interval from the flange surface at the assembly completion position, connects a root of the inner circumferential lip to a root on a side of the main body of the inner circumference portion of the main body or/and the outer circumferential lip, receives force from the inner circumferential lip at the attachment completion position, and bend-deforms toward a side of the flange surface.

2. The grommet according to claim 1, wherein
the connection member is formed into an annular shape coaxially arranged at an interval from the flange surface at the assembly completion position, and
the inner circumferential lip is coaxially protruded from an inner circumference portion of the connection member toward the circumference portion.

3. The grommet according to claim 1, wherein
the connection member is arranged at an interval from the flange surface even at the attachment completion position.

4. The grommet according to claim 2, wherein
the connection member is arranged at an interval from the flange surface even at the attachment completion position.

5. The grommet according to claim 1, wherein
the outer circumferential lip is protruded toward the circumference portion in such a manner as to be separated from a hole axis of the through-hole as coaxially getting closer to the circumference portion from the main body.

6. The grommet according to claim 2, wherein
the outer circumferential lip is protruded toward the circumference portion in such a manner as to be separated from a hole axis of the through-hole as coaxially getting closer to the circumference portion from the main body.

7. The grommet according to claim 1, wherein
the outer circumferential lip is protruded toward the circumference portion in such a manner as to be separated from a hole axis of the through-hole as coaxially getting closer to the circumference portion from the main body, and
the inner circumferential lip vertically installs a wall surface on a side of the outer circumferential lip from the connection member.

8. The grommet according to claim 2, wherein
the outer circumferential lip is protruded toward the circumference portion in such a manner as to be separated from a hole axis of the through-hole as coaxially getting closer to the circumference portion from the main body, and
the inner circumferential lip vertically installs a wall surface on a side of the outer circumferential lip from the connection member.
